(19) United States
(12) Patent Application Publication
(10) Pub. No.: US 2026/0093041 A1
(43) Pub. Date: Apr. 2, 2026

(54) Avionic System with Pseudolite-Based Positioning

(71) Applicant: Joby Aero, Inc., Santa Cruz, CA (US)

(72) Inventors: Michael Alexei Burghardt, Santa Cruz, CA (US); Karsten Andreas Mueller, Karlsruhe (DE)

(21) Appl. No.: 18/891,776

(22) Filed: Sep. 20, 2024

Related U.S. Application Data
(60) Provisional application No. 63/583,992, filed on Sep. 20, 2023.

(51) Int. Cl. G01S 19/11

(52) U.S. Cl. CPC G01S 19/11

(57) ABSTRACT

A method for avionic positioning includes computing a position estimate of the aircraft based at least in part on data corresponding to a signal from each of a plurality of global navigation satellites and data corresponding to a signal from each of at least one pseudolite. A clock of a computing device for computing the position estimate is synchronized to time of the global navigation satellites, and the clock has a timing error less than one microsecond per twenty-four hours.

### CROSS-REFERENCE TO RELATED APPLICATION

The present application is related and has right of priority to U.S. Provisional Patent Application No. 63/583,992, which was filed on September 20, 2023 and is incorporated by reference in its entirety for all purposes.

### FIELD

The present disclosure relates generally to pseudolite-based aircraft positioning.

### BACKGROUND

During navigation, aircraft can utilize data from a global navigation satellite system (GNSS) for measuring a location of the aircraft. The accuracy of GNSS systems varies by environment and can be unavailable in certain instances. Moreover, GNSS-based positioning estimates can be coarse and not provide a required integrity for autonomous flight. In general, conventional GNSS systems can lack the availability, continuity, and integrity needed for aircraft navigation during autonomous flight and other operating conditions.

Systems and methods for high-integrity aircraft location estimates would be useful.

### SUMMARY

Aspects and advantages of embodiments of the present disclosure will be set forth in part in the following description, or may be learned from the description, or may be learned through practice of the embodiments.

In example embodiments, a method for avionic positioning includes: accessing, with a computing device on an aircraft, data corresponding to a signal from each of a plurality of global navigation satellites; accessing, with the computing device, data corresponding to a signal from each of at least one pseudolite, each of the at least one pseudolite synchronized to a time of the global navigation satellites; and computing, with the computing device, a position estimate of the aircraft based at least in part on the data corresponding to the signal from each of the plurality of global navigation satellites and the data corresponding to the signal from each of the at least one pseudolite, wherein a clock of the computing device is synchronized to the time of the global navigation satellites, and the clock has a timing error less than one microsecond per twenty-four hours.

In example embodiments, a system for avionic positioning includes an aircraft and one or more processors located onboard the aircraft. A clock is in communication with the one or more processors. One or more non-transitory computer-readable media store instructions that are executable by the one or more processors to perform operations. The operations include accessing data corresponding to a signal from each of a plurality of global navigation satellites, accessing data corresponding to a signal from each of at least one pseudolite when each of the at least one pseudolite is synchronized to a time of the global navigation satellites, and computing a position estimate of the aircraft based at least in part on the data corresponding to the signal from each of the plurality of global navigation satellites and the data corresponding to the signal from each of the at least one pseudolite. The clock is synchronized to the time of the global navigation satellites, and the clock has a timing error less than one microsecond per twenty-four hours.

In example embodiments, a method for avionic positioning includes: accessing, with a first computing device on an aircraft, data corresponding to a signal from each of a plurality of global navigation satellites; accessing, with a second computing device on the aircraft, data corresponding to a signal from each of at least one pseudolites, each of the at least one pseudolites synchronized to a time of the global navigation satellites; computing an offset estimate between a clock of the first computing device and a clock of the second computing device, wherein the clock of the second computing device has a timing error less than one microsecond per twenty-four hours; and computing a position estimate of the aircraft based at least in part on the data corresponding to the signal from each of the plurality of global navigation satellites, the data corresponding to the signal from each of the at least one pseudolites, and the offset estimate.

In example embodiments, a system for avionic positioning includes an aircraft. A global navigation satellite system is located onboard the aircraft. The global navigation satellite system is configured for receiving data corresponding to a signal from each of a plurality of global navigation satellites. The global navigation satellite system includes a clock. A pseudolite navigation system is located onboard the aircraft. The pseudolite navigation system is configured for receiving data corresponding to a signal from each of at least one pseudolite. The pseudolite navigation system includes a clock with a timing error less than one microsecond per twenty-four hours, one or more processors, and one or more non-transitory computer-readable media that store instructions that are executable by the one or more processors to perform operations. The operations include accessing data corresponding to the signal from each of at least one pseudolites when each of the at least one pseudolites is synchronized to a time of the global navigation satellites, computing an offset estimate between the clock of the global navigation satellite system and the clock of the pseudolite navigation system, and computing a position estimate of the aircraft based at least in part on the data corresponding to the signal from each of the plurality of global navigation satellites, the data corresponding to the signal from each of the at least one pseudolites, and the offset estimate.

These and other features, aspects and advantages of various embodiments will become better understood with reference to the following description and appended claims. The accompanying drawings, which are incorporated in and constitute a part of this specification, illustrate embodiments of the present disclosure and, together with the description, serve to explain the related principles.

### BRIEF DESCRIPTION OF THE DRAWINGS

Detailed discussion of embodiments directed to one of ordinary skill in the art are set forth in the specification, which makes reference to the appended figures.

FIG. 1 is a perspective view of an aircraft according to an example embodiment of the present disclosure in a thrust-borne flight regime.

FIG. 2 is a perspective view of the example aircraft of FIG. 1 in a horizontal flight configuration.

FIG. 3 is a schematic view of an electrical system according to an example embodiment of the present disclosure.

FIG. 4 is a schematic view of an avionics system according to an example embodiment of the present disclosure.

FIG. 5 is a schematic view of a pseudolite navigation system according to an example embodiment of the present disclosure.

FIG. 6 is a schematic view of a pseudolite and satellite navigation system according to an example embodiment of the present disclosure.

FIG. 7 is a schematic view of a pseudolite for aircraft positioning according to an example embodiment of the present disclosure.

FIG. 8 is a schematic view of an aircraft using signals from satellites and a pseudolite for positioning according to an example embodiment of the present disclosure.

FIG. 9 is a schematic view of an aircraft using signals from satellites and pseudolites for positioning according to an example embodiment of the present disclosure.

FIG. 10 is a schematic view of an aircraft using signals from pseudolites for positioning according to an example embodiment of the present disclosure.

FIG. 11 is a flowchart of a pseudolite-based positioning method for an aircraft according to an example embodiment of the present disclosure.

FIG. 12 is a diagram of example computing components according to an example embodiment of the present disclosure.

Repeat use of reference characters in the present specification and drawings is intended to represent the same or analogous features or elements of the present invention.

### DETAILED DESCRIPTION

The present subject matter may advantageously provide a positioning system, which can utilize pseudolite signals to provide estimates of various operational parameters of the aircraft, such as a position estimate and a velocity estimate. Moreover, the positioning system may provide such estimates during all phases of flight, e.g., without reference to a global navigation satellite system (GNSS). The position and/or velocity estimates may be used to assist with fully autonomous flight of an aircraft. The pseudolite-based positioning system may advantageously increase integrity of the positioning estimates and/or allow for navigation of the aircraft when GNSS navigation inputs are unavailable. The positioning system may thus provide accurate position estimates and/or velocity estimates for the aircraft, e.g., even without GNSS measurements.

In example embodiments, position estimates and/or velocity estimates based on data from one or more pseudolites may be utilized during various phases of flight. For instance, the pseudolite-based position and/or velocity estimates may be utilized during one more of: (1) takeoff; (2) initial climb; (3) en-route; (4) approach; and (5) landing. Thus, one or more ground-based pseudolites may transmit signals during the phases of flight, and the positioning system can calculate a position estimate and/or a velocity estimate for the aircraft based at least in part on the pseudolite signals during each of the phases of flight. Advantageously, the ground-based pseudolites may be simultaneously utilized by multiple aircraft, e.g., as a one-way ranging system.

Reference now will be made in detail to embodiments, one or more examples of which are illustrated in the drawings. Each example is provided by way of explanation of the embodiments, not limitation of the present disclosure. In fact, it will be apparent to those skilled in the art that various modifications and variations can be made to the embodiments without departing from the scope or spirit of the present disclosure. For instance, features illustrated or described as part of one embodiment can be used with another embodiment to yield a still further embodiment. Thus, it is intended that aspects of the present disclosure cover such modifications and variations.

Example aspects of the present disclosure are described below in the context of an example aircraft 100 configured for vertical take-off and landing as well as horizontal flight. It will be understood that aircraft is provided by way of example only and that the present subject matter is not limited to aircraft 100 or vertical take-off and landing aircraft more generally. The present subject matter including may be utilized in other aircraft in other example embodiments. For example, the present subject matter may be used in or with conventional take-off and landing aircraft, VTOL aircraft, multi-modal aircraft, tilt propeller aircraft, helicopters, etc.

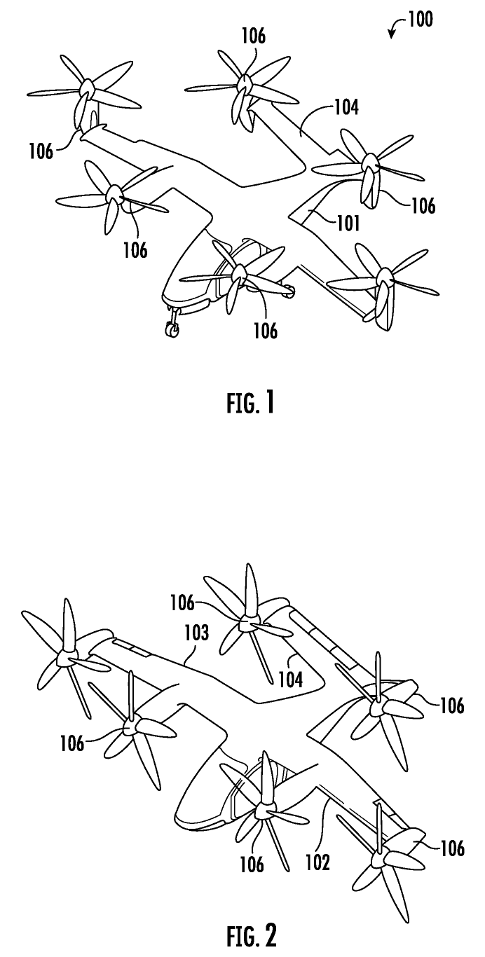

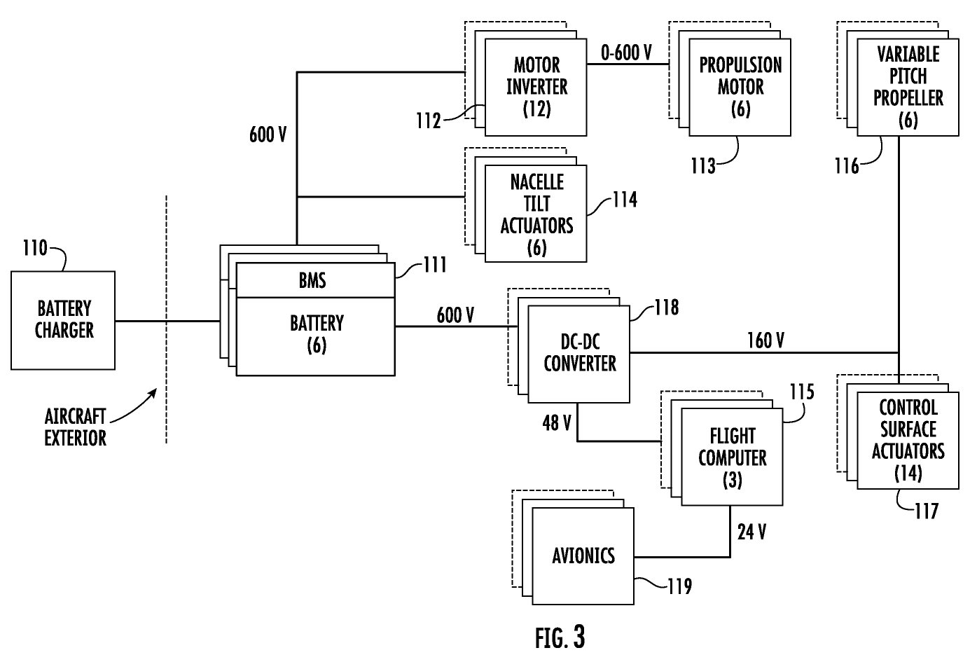

FIGS. 1 and 2 are perspective views of an aircraft 100 configured for vertical take-off and landing as well as horizontal flight according to an example embodiment of the present disclosure. In FIG. 1, aircraft 100 is in a thrust-borne flight regime or hover configuration. In FIG. 2, the aircraft 100 is in a wing-borne flight regime or high-speed configuration. As shown in FIGS. 1 and 2, the aircraft 100 may include tilt propulsion units 106 with bladed propellers powered by electric motors. The tilt propulsion units 106 may provide thrust during take-off and forward flight of the aircraft 100. Moreover, the tilt propulsion units 106 may be rotated relative to fixed wings of the aircraft 100 between the thrust-borne flight regime shown in FIG. 1 and the wing-borne flight regime shown in FIG. 2.

In the thrust-borne flight regime, the propellers of the tilt propulsion units 106 may be oriented to primarily or predominately provide vertical thrust for take-off and landing. In the wing-borne flight regime, the propellers of the tilt propulsion units 106 may be oriented to primarily or predominately provide forward thrust for high-speed flight. In example embodiments, both the electric motor and the propellers of the tilt propulsion units 106 may be together rotated when the aircraft 100 adjusts between the thrust-borne flight regime of FIG. 1 and the wing-borne flight regime of FIG. 2. Thus, the tilt propulsion units 106 may allow for directional change of thrust without requiring any gimbaling, or other method, of torque drive around or through a rotating joint.

In some example aspects, the aircraft 100 take offs from the ground with vertical thrust from the tilt propulsion units 106 in the thrust-borne flight regime. As the aircraft 100 gains altitude, the tilt propulsion units 106 may begin to tilt forward in order to begin forward acceleration. As the aircraft 100 gains forward speed, airflow over the wings results in lift, such that the tilt propulsion units 106 become less important and then unnecessary for maintaining altitude using vertical thrust. Once the aircraft 100 reaches sufficient forward speed, the tilt propulsion units 106 may be oriented to provide forward thrust in the wing-borne flight regime, and the aircraft 100 may continue to gain speed.

As shown in FIGS. 1 and 2, the aircraft 100 may include an aircraft body 101 and fixed wings 102, 103, which may be forward swept wings, including a left wing 102 and a right wing 103. At least some of tilt propulsion units 106 may be mounted on the wings 102, 103. As noted above, the tilt propulsion units 106 may include electric motors and propellers, which are configured to articulate between the thrust-borne flight regime shown in FIG. 1 and the wing-borne flight regime shown in FIG. 2.

The aircraft body 101 may extend rearward and be attached to raised rear stabilizers 104. At least some of tilt propulsion units 106 may also be attached to the rear stabilizers 104. The tilt propulsion units 106 on the rear stabilizers 104 may be articulated between the thrust-borne flight regime shown in FIG. 1 and the wing-borne flight regime shown in FIG. 2 by rotating along a pivot axis such that the nacelle, the electric motor, and the propeller deploy in unison.

The aircraft 100 may also include any suitable set of flight actuators, which functions to transform aerodynamic forces/moments of the aircraft to affect aircraft control. Flight actuators may include control surface actuators (e.g., configured to drive control surfaces), tilt linkages (e.g., which actuate the tilt propulsion units 106 between the forward flight and hover configurations), variable blade pitch actuators (e.g., for variable blade pitch for the propellers of the tilt propulsion units 106), and/ or any other suitable actuators. Control surfaces may include flaps, elevators, ailerons, rudders, ruddervators, spoilers, slats, air brakes, and/or any other suitable control surfaces.

In the example shown in FIGS. 1 and 2, the aircraft 100 may include two passenger seats side by side, as well as landing gear under the aircraft body 101. Although aircraft 100 is shown as a two-passenger aircraft, other numbers of passengers may be accommodated in other example embodiments of the present disclosure. The landing gear (e.g., retractable landing gear, fixed landing gear) may be configured to structurally support the aircraft 100 when the aircraft 100 is in contact with the ground and/or maneuver the aircraft 100 during taxi.

Again, it will be understood that the aircraft 100 is provided by way of example. The present subject matter may also be used in or with other aircraft in alternative example embodiments. For example, the present subject matter may be used in or with fixed-wing aircraft, VTOL aircraft, multi-modal aircraft, tilt propeller aircraft, helicopters, etc. The propulsion units may have a fixed or variable pitch. The aircraft may include an all-electric powertrain, e.g., with battery powered electric motors, for the propulsion units. In alternative example embodiments, may include a hybrid powertrain, such as a gas-electric hybrid with an internal-combustion generator, or an internal-combustion powertrain, such as a gas-turbine engine, a turboprop engine, etc. The present subject matter may be used in or with conventional take-off and landing aircraft.

FIG. 3 is schematic view of an electrical system for the aircraft 100. As shown, the electrical system may include batteries 111, e.g., six (6) batteries 111. In an example, each of the batteries 111 may supply two power inverters 112. Thus, an example implementation of the electrical system may include twelve (12) power inverters 112. The nominal voltage of the batteries may be six hundred volts (600V) in example embodiments. Each of the propulsion motors 113 may include two sets of windings, with each motor 113 powered by two inverters 112, one for each set of windings. The two inverters 112 powering a single motor 113 each may be supplied power by different batteries 111. In addition to supplying power to the motor inverters 112, the battery 111 may also supply power to tilt actuators 114, such as tilt actuators, which are used to deploy and stow the tilt propulsion units 106 during various flight modes, such as the thrust-borne flight regime and the wing-borne flight regime.

A flight computer 115 may monitor the current from each of the motor inverters 112, which are supplying power to the winding sets in the motors 113. The flight computer 115 may also control the motor current supplied to each of the windings of the motors 113. In example embodiments, the batteries 111 may also supply power to blade pitch motors 116 and position encoders of the tilt propulsion units 106. The batteries 111 may also supply power to one or more actuators 117, such as control surface actuators configured to adjust the position of various control surfaces on the aircraft 100.

The blade pitch motors 116 and the actuators 117 may receive power through a DC-DC converter 118, which may step the voltage from six hundred volts (600V) to one hundred and sixty volts (160V), for example. A suite of avionics 119 may also be coupled to the flight computer 115. A battery charger 110 may be used to recharge the batteries 111, and the battery charger 110 may be located external to the aircraft 100 and ground based.

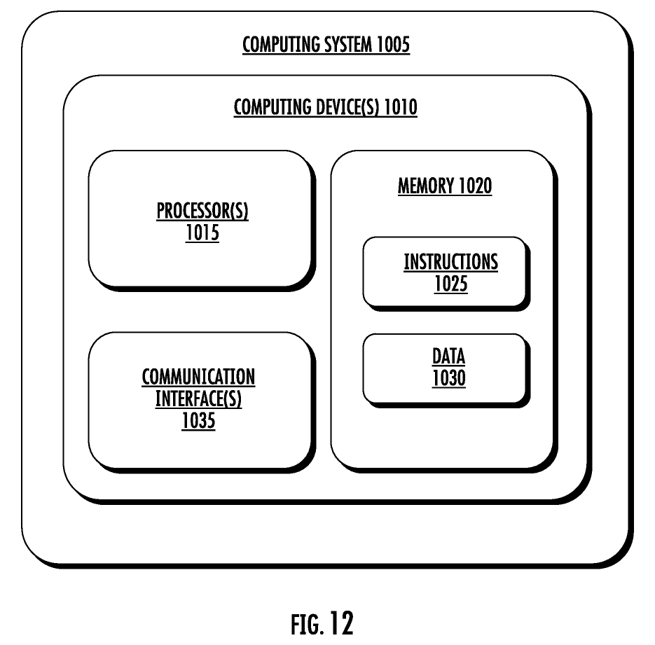

The flight computer 115 may be configured to generate commands that may be transmitted to and interpreted by the inverters 112 and/or actuators 117 to control aircraft flight. In example embodiments with a plurality of flight computers 115, each of the flight computers 115 may be a substantially identical instance of the same computer architecture and components, but can additionally or alternatively be instances of distinct computer architectures and components (e.g., generalized processors manufactured by different manufacturers). The flight computers 115 may include CPUs, GPUs, TPUs, ASICs, microprocessors, and/or any other suitable set of processing systems. In example embodiments, each of the flight computers 115 performs substantially identical operations (e.g., processing of data, issuing of commands, etc.) in parallel, and are connected (e.g., via the distribution network) to the same set of flight components. FIG. 12 provides additional detail regarding example components of a computing system, such as a flight computer 115.

The flight computer 115 may be programmed to control operation of the aircraft 100. For example, flight computer 115 may receive positioning data and/or navigation data from avionics 119, and flight computer 115 may generate commands that may be transmitted to and interpreted by the inverters 112 and/or actuators 117 to control aircraft flight in order navigate the aircraft 100 to a destination.

As described in greater detail below, the avionics 119 may be programmed or configured to provide a positioning system 170 (FIG. 4) that computes a position estimate and/or a velocity estimate for the aircraft 100 based at least in part on pseudolite signals. The positioning system 170 may provide the position estimate and/or the velocity estimate for the aircraft 100 during all phases of flight, e.g., without reference to global navigation satellite system (GNSS) signals.

FIG. 4 is a schematic view of certain portions of the avionics 119 of aircraft 100, including a positioning system 170. As shown in FIG. 4, avionics 119 may include an avionics computer 120. The avionics computer 120 may be configured to access data from various components of the avionics 119. For instance, avionics computer 120 may be in signal communication with systems of avionics 119, such as a global satellite navigation system 130, a pseudolite navigation system 140, an inertial measurement system 150, a pressure sensor 160, etc., e.g., via a communication bus or other suitable wired or wireless communication mechanism. Avionics computer 120 may thus receive data from and/or transmit data to the global satellite navigation system 130, the pseudolite navigation system 140, the inertial measurement system 150, and the pressure sensor 160. The avionics computer 120 may also be configured to processes data in order to, e.g., estimate a position and/or velocity of the aircraft 100 during flight. As another example, avionics computer 120 may be configured to generate data corresponding to navigation instructions for aircraft 100 during autonomous flight, e.g., based at least in part on the estimates of the position and/or velocity of the aircraft 100.

The positioning system 170 may include the global satellite navigation system 130, the pseudolite navigation system 140, the inertial measurement system 150, and the pressure sensor 160. It will be understood that only relevant portions of the complete positioning system for an aircraft are shown in FIG. 4. Other components are omitted for the sake of brevity. Thus, the positioning system 170 may include additional positioning components in other example embodiments. The positioning system 170 in FIG. 4 may be implemented as at least a portion of, or otherwise be in communication with, the avionics computer 120 and/or the flight computer 115. Positioning system 170 is described in greater detail below in the context of the aircraft 100, which was described with reference to FIGS. 1 through 3. In this regard, estimates of the altitude and/or velocity of the aircraft 100 may be computed by the positioning system 170 to assist with operating or navigating the aircraft 100. However, it will be understood that the positioning system 170 may be used in or with other aircraft in alternative example embodiments.

When GNSS positioning data is available, the positioning system 170 may provide high integrity position and/or velocity estimates during all phases of flight by utilizing pseudolite-based estimates in combination with GNSS positioning data. In some circumstances, the aircraft 100 may operate without access to the GNSS positioning data. The positioning system 170 may provide pseudolite-based position and/or velocity estimates for the aircraft 100 during all phases of flight, e.g., without reference to GNSS positioning data.

The global satellite navigation system 130 may be configured for receiving signals from satellites and calculating a position and/or velocity of the aircraft 100 based on the signals from the satellites. In example embodiments, the global satellite navigation system 130 may be a global positioning system (GPS), a global navigation satellite system (GLONASS), a BeiDou navigation satellite system, a Galileo system, and/or other satellite navigation system, such as a low-orbit satellite navigation system. The avionics computer 120 may receive data from the global satellite navigation system 130 corresponding to estimates of the position and/or velocity of the aircraft 100 based on signals from the satellites. As another example, the avionics computer 120 may receive data from the global satellite navigation system 130 and compute estimates of the position and/or velocity of the aircraft 100 based on the data.

The pseudolite navigation system 140 may be configured for receiving signals from one or more ground-based pseudolites and calculating a position and/or velocity of the aircraft 100 based on the signals from the pseudolites. The avionics computer 120 may receive data from the pseudolite navigation system 140 corresponding to estimates of the position and/or velocity of the aircraft 100 based on signals from the pseudolite(s). As another example, the avionics computer 120 may receive data from the pseudolite navigation system 140 and compute estimates of the position and/or velocity estimates of the aircraft 100 based on the data.

The inertial measurement system 150 may be configured for measuring and reporting various operating parameters of the aircraft 100, such as a specific force, an angular rate, an orientation, etc., of aircraft 100 during flight. The inertial measurement system 150 may include various sensors, including one or more of an accelerometer, a gyroscope, and a magnetometer. Moreover, in certain example embodiments, the inertial measurement system 150 may include one accelerometer, one gyroscope, and one magnetometer per each principal axis of the aircraft, namely pitch, roll and yaw. The data from the inertial measurement system 150 may be used to calculate attitude, velocity, and position of the aircraft 100 for the three principal axes of the aircraft. It will be understood that the arrangement of the inertial measurement system 150 described above is provided by way of example and that the inertial measurement system 150 may be any suitable conventional inertial measurement system, which are well understood by those of skill in the art. As noted above, the inertial measurement system 150 may be in signal communication with the avionics computer 120. Thus, the avionics computer 120 may receive data from the inertial measurement system 150 corresponding to estimates of the attitude, velocity, and position of the aircraft 100 based on inertial measurements by the inertial measurement system 150. As another example, the avionics computer 120 may receive data from the inertial measurement system 150 and compute estimates of attitude, velocity, and position of the aircraft 100 based on the inertial measurements by the inertial measurement system 150.

The pressure sensor 160 may be configured for measuring an air pressure about the aircraft 100 and reporting an altitude of the aircraft 100 based on the measured air pressure. Thus, the pressure sensor 160 may include a barometer that senses ambient, static air pressure, e.g., via a static port on the aircraft body 101. It will be understood that the arrangement of the pressure sensor 160 described above is provided by way of example and that the pressure sensor 160 may be any suitable conventional pressure altimeter, which are well understood by those of skill in the art. As noted above, the pressure sensor 160 may be in signal communication with the avionics computer 120. Thus, the avionics computer 120 may receive data from the pressure sensor 160 corresponding to estimates of altitude of the aircraft 100 based on pressure measurements by the pressure sensor 160. As another example, the avionics computer 120 may receive data from the pressure sensor 160 and compute estimates of altitude based on the pressure measurements by the pressure sensor 160.

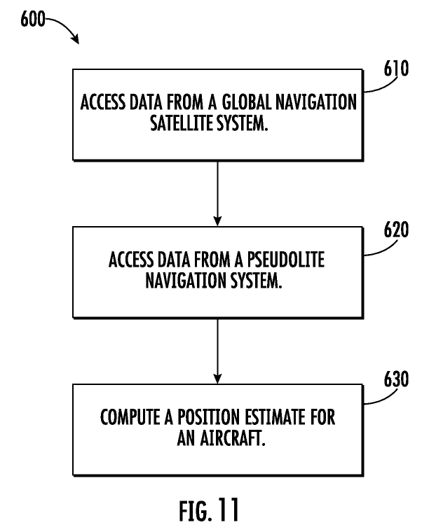

In example embodiments with a plurality of avionics computers 120, each of the avionics computer 120 may be a substantially identical instance of the same computer architecture and components, but can additionally or alternatively be instances of distinct computer architectures and components (e.g., generalized processors manufactured by different manufacturers). The avionics computer 120 may include CPUs, GPUs, TPUs, ASICs, microprocessors, and/or any other suitable set of processing systems. In example embodiments, each of the avionics computer 120 performs distinct operations (e.g., processing of data, estimating of flight parameters, etc.) in parallel, and are connected (e.g., via the distribution network) to the avionics computers 120. FIG. 11 provides additional detail regarding example components of a computing system, such as the avionics computer 120.

FIG. 5 is a schematic view of certain portions of the pseudolite navigation system 140. It will be understood that only relevant portions of the complete pseudolite navigation system 140 are shown in FIG. 5. Other components are omitted for the sake of brevity. Thus, the pseudolite navigation system 140 may include additional components in other example embodiments. For instance, the pseudolite navigation system 140 may include CPUs, GPUs, TPUs, ASICs, microprocessors, and/or any other suitable set of processing systems. FIG. 11 provides additional detail regarding example components of a computing system, such as the pseudolite navigation system 140.

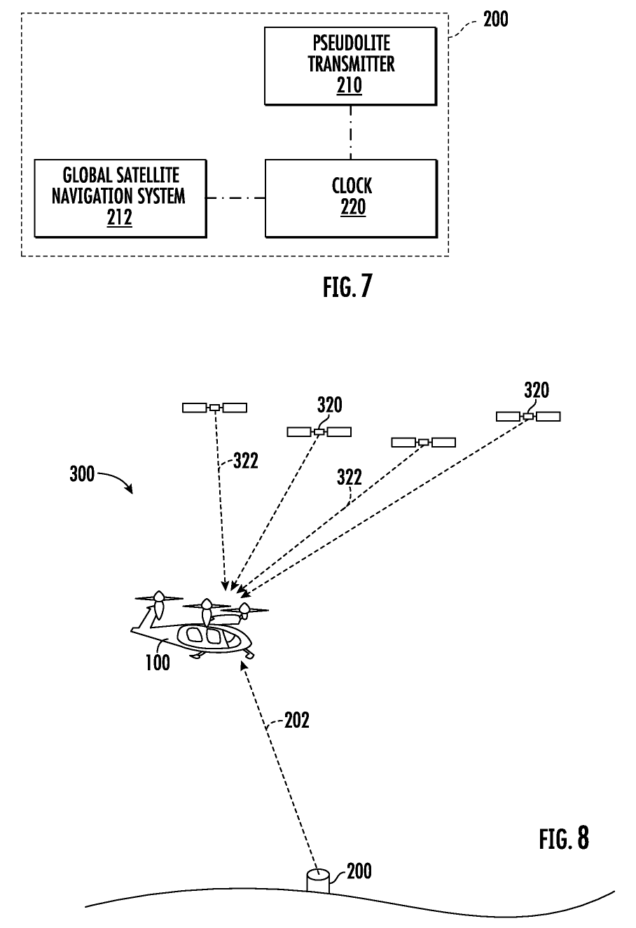

As shown in FIG. 5, the pseudolite navigation system 140 may include a pseudolite receiver 142 and a clock 144. The pseudolite receiver 142 may include one or more antennas tuned to transmission frequencies of ground-based pseudolites, such as a pseudolite 200 (FIG. 7). Thus, the pseudolite receiver 142 may receive signals from the ground-based pseudolites via the antennas. The clock 144 may be synchronized to a clock of the pseudolites and/or to GNSS time. In other example embodiments, the pseudolite navigation system 140 may be configured for calculating a clock offset estimate between the clock 144 and GNSS time, e.g., to nanosecond accuracy. In example embodiments, GNSS time may correspond to a time of one of a global positioning system (GPS), a global navigation satellite system (GLONASS), a BeiDou navigation satellite system, a Galileo system, and/or other satellite navigation system, such as a low-orbit satellite navigation system

The pseudolite navigation system 140 may be configured for measuring a time of arrival for each signal from pseudolites received at the pseudolite receiver 142 based on the time of the clock 144. The pseudolite navigation system 140 may compute a position estimate for the aircraft 100 using the times of arrival for signals from the pseudolites at the pseudolite receiver 142, as discussed in greater detail below. The pseudolite navigation system 140 may also compute a difference between a transmission frequency of the signals from the pseudolites relative to an arrival frequency of the signals from the pseudolites at the pseudolite navigation system 140. The pseudolite navigation system 140 may compute a velocity estimate for the aircraft 100 using the frequency difference or Doppler shift for the signals, which is also referred to as a pseudorange rate. In example embodiments, the pseudolite navigation system 140 may be configured for carrier phase measurement in order to determine a phase range measurement, and the pseudolite navigation system 140 may be configured for smoothing noisy pseudorange measurements with the precise carrier phase measurements.

In certain example embodiments, the pseudolite receiver 142 may include an array of antennas spaced apart from one another. For example, the antennas of the pseudolite receiver 142 may be spaced apart along one or more of a pitch axis, a roll axis, and a yaw axis of the aircraft 100. Thus, e.g., when the aircraft 100 is grounded, the antennas of the pseudolite receiver 142 may be vertically and/or horizontally spaced apart. The array of antennas may be configured for calculating an angle of arrival estimate for signals from a pseudolite.

The clock 144 may be highly stable. For instance, the clock 144 of the pseudolite navigation system 140 may have a timing error less than one microsecond per twenty-four hours (< 1µs/24hrs). In certain example embodiments, the clock 144 of the pseudolite navigation system 140 may include a chip scale atomic clock, a miniature atomic clock, or other very precise, low SWAP-C clock that can be installed in the pseudolite navigation system 140 onboard the aircraft 100. By utilizing the clock 144 having the above-described timing error, the pseudolite navigation system 140 can advantageously calculate a vertical position estimate for the aircraft 100 with significantly greater integrity relative to using other clocks with greater timing errors. In addition, the utilizing the clock 144 having the above-described timing error, the pseudolite navigation system 140 can advantageously provide high integrity position and/or velocity estimates even without access to GNSS positioning data, such during GNSS spoofing and/or jamming.

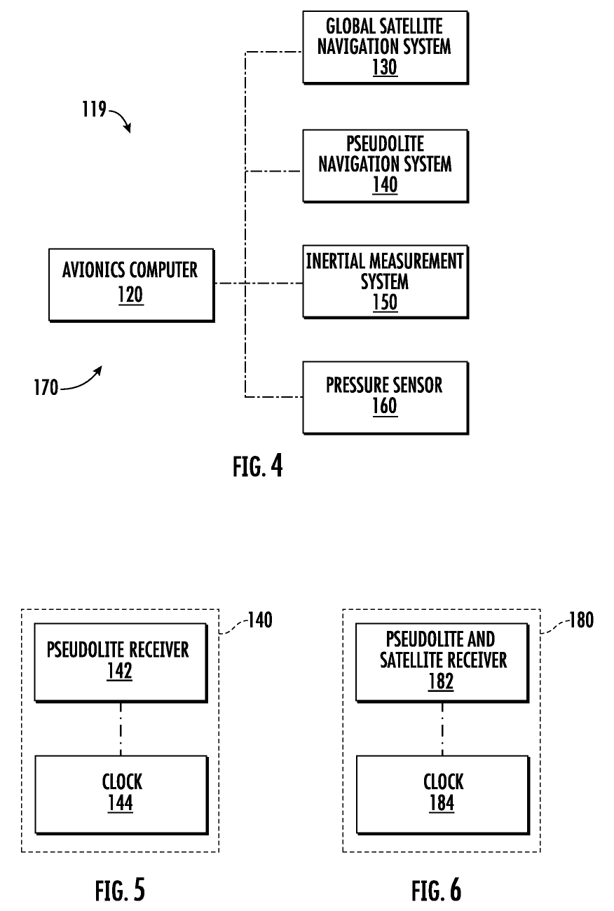

As shown in FIG. 6, in certain example embodiments, the global satellite navigation system 130 and the pseudolite navigation system 140 may be combined into a system 180. Thus, a single, combined pseudolite and satellite navigation system 180 may be configured for receiving signals from satellites as well as from ground-based pseudolites to estimate a position and/or velocity of the aircraft 100.

As shown in FIG. 6, the system 180 may include a pseudolite and satellite receiver 182 and a clock 184. The pseudolite and satellite receiver 182 may include one or more antennas tuned to transmission frequencies of ground-based pseudolites, such as a pseudolite 200 (FIG. 7), as well as transmission frequencies of orbiting satellites. Thus, the pseudolite and satellite receiver 182 may receive signals from the ground-based pseudolites via the antennas as well as signals from the orbiting satellites via the antennas. The clock 184 may be synchronized to the time of the satellites and pseudolites.

With respect to pseudolite-based position estimates, the system 180 may be configured for measuring a time of arrival for each signal from the pseudolites received at the pseudolite and satellite receiver 182 based on the time of the clock 184. The system 180 may compute a position estimate for the aircraft 100 using the times of arrival for signals from the pseudolites at the pseudolite and satellite receiver 182, as discussed in greater detail below. With respect to pseudolite-based velocity estimates, the system 180 may be configured for determining a difference between a transmission frequency of the signals from the pseudolites relative to an arrival frequency of the signals from the pseudolites at the pseudolite and satellite receiver 182. The system 180 may compute a velocity estimate for the aircraft 100 using the frequency difference or Doppler shift for the signals, which is also referred to as a pseudorange rate. In example embodiments, the system 180 may be configured for carrier phase measurement in order to determine a phase range measurement, and the system 180 may be configured for smoothing noisy pseudorange measurements with the precise carrier phase measurements.

With respect to satellite-based position estimates, the system 180 may be configured for measuring a time of arrival for each signal from the satellites received at the pseudolite and satellite receiver 182 based on the time of the clock 184. The system 180 may compute a position estimate for the aircraft 100 using the times of arrival for signals from the satellites at the pseudolite and satellite receiver 182, as discussed in greater detail below. With respect to satellite-based velocity estimates, the system 180 may be configured for determining a difference between a transmission frequency of the signals from the satellites relative to an arrival frequency of the signals from the satellites at the pseudolite and satellite receiver 182. The system 180 may compute a velocity estimate for the aircraft 100 using the frequency difference or Doppler shift for the signals. In example embodiments, the system 180 may be configured for carrier phase measurement in order to determine a phase range measurement, and the system 180 may be configured for smoothing noisy pseudorange measurements with the precise carrier phase measurements.

The pseudolite and satellite receiver 182 may receive signals from pseudolites and satellites simultaneously or at different times, e.g., depending upon signal availability from the pseudolites and satellites. In certain example embodiments, the system 180 may calculate separate position and/or velocity estimates for the aircraft 100 based upon the data from the pseudolites and satellites. As another example, the system 180 may calculate position and/or velocity estimates for the aircraft 100 based upon both data from the pseudolites and data from the satellites.

FIG. 7 is a schematic view of a pseudolite 200 for aircraft positioning. It will be understood that only relevant portions of the complete pseudolite 200 are shown in FIG. 7. Other components are omitted for the sake of brevity. Thus, the pseudolite 200 may include additional components in other example embodiments. For instance, the pseudolite 200 may include CPUs, GPUs, TPUs, ASICs, microprocessors, and/or any other suitable set of processing systems. FIG. 11 provides additional detail regarding example components of a computing system, such as the pseudolite 200.

As shown in FIG. 7, the pseudolite 200 includes a pseudolite transmitter 210 and a clock 220. The pseudolite transmitter 210 may include one or more antennas tuned for selected transmission frequencies. Thus, the pseudolite transmitter 210 may transit signals, which may be received by the pseudolite navigation system 140 via pseudolite receiver 142. The clock 220 may be synchronized to clocks of the satellites of a GNSS system. The pseudolite 200 may be configured for encoding the time of transmission onto the signals from the pseudolite transmitter 210 based on the time of the clock 220.

The clock 220 may be highly stable. For instance, the clock 220 of the pseudolite 200 may have a timing error less than one microsecond per twenty-four hours (< 1µs/24hrs). In certain example embodiments, the clock 220 of the pseudolite 200 may include a chip scale atomic clock, a miniature atomic clock, or other very precise, low SWAP-C clock that can be installed in the pseudolite 200. By utilizing the clock 220 having the above-described timing error, the pseudolite 200 can advantageously transmit accurate time of transmissions for signals from the pseudolite 200. In addition, the clock 220 having the above-described timing error can advantageously allow extended operation of the pseudolite 200 even without access to GNSS positioning data, such during GNSS spoofing and/or jamming. Thus, e.g., the pseudolite 200 may transmit signals with accurate time of transmissions even when unable to synchronize the clock 220 to GNSS time.

The pseudolite 200 may also include a global satellite navigation system 212, which may be configured for receiving signals from satellites and synchronizing the clock 220 to GNSS time. In example embodiments, the global satellite navigation system 212 may be a global positioning system (GPS), a global navigation satellite system (GLONASS), a BeiDou navigation satellite system, a Galileo system, and/or other satellite navigation system, such as a low-orbit satellite navigation system.

The pseudolite 200 may be installed at any suitable location. For instance, a plurality of pseudolites 200 may be installed along a flight path for the aircraft 100. As another example, a plurality of pseudolites 200 may be installed at a landing area for the aircraft 100, such as a landing pad or strip. The location of the pseudolite 200 on the ground may be known. For instance, the latitude, longitude, and latitude of the pseudolite 200 may be measured or determined. The pseudolite 200 may be configured for encoding the location of the pseudolite 200 onto the signals from the pseudolite transmitter 210, e.g., in addition to the time of transmission for the signals. Signals from the pseudolite 200 may also include other information in addition to the location of the pseudolite 200. For example, the signals of the pseudolite 200 may include authentication data. Moreover, the signals of the pseudolite 200 may be encrypted to increase security of the positioning system 170. In example emodiments, the locations of the pseudolites 200 may be stored in a database, such as a look-up table, on-board the aircraft 100 or transmitted via a data link, separate from the pseudolite 200 to the aircraft 100.

For an array of pseudolites 200, the clock 220 of at least one of the pseudolites 200 may be highly stable, e.g., such that the timing error of the clock 220 is less than one microsecond per twenty-four hours (< 1µs/24hrs). The highly stable clock 220 may be synchronized to the time of a GNSS system, and the clocks of the other pseudolites 200 may be synchronized to the highly stable clock 220, e.g., via cabling or line-of-sight links. It will be understood that in certain example embodiments, each of the clocks 220 of the pseudolites 200 may be highly stable, e.g., such that the timing error of the clock 220 is less than one microsecond per twenty-four hours (< 1µs/24hrs). Utilizing clocks 220 with the above-described timing error may advantageously allow for operation of the pseudolites 200 with acceptable accuracy for no less than one hour (1 hr.), such as no less than two hours (2 hrs.), without synchronization to the time of a GNSS system. Thus, signals from the pseudolites 200 may be used by the positioning system 170 for positioning and/or velocity estimates of the aircraft 100 without access to GNSS data.

With reference to FIGS. 4, 5, and 7, the pseudolite navigation system 140 on the aircraft 100 may be configured for estimating the position of the aircraft 100 based at least in part on data from one or more pseudolites 200 fixed on the ground below the aircraft 100. For instance, the pseudolite navigation system 140 may be configured for calculating the time of arrival for signals from the pseudolite 200 based on the time of the clock 144. As noted above, the signals from the pseudolite 200 may include time of transmissions for the signals based on the clock 220 of the pseudolite 200. The pseudolite navigation system 140 may calculate a time of flight for the signals from the pseudolite 200 to the pseudolite receiver 142 based on the time of transmission for the signal from the pseudolite 200 and the time of arrival of the signals at the aircraft 100. For instance, the pseudolite navigation system 140 may utilize the time of flight and the speed of the signals e.g., the speed of light, to calculate a distance estimate between the aircraft 100 and the pseudolite 200. With multiple (e.g., three, four, or more) pseudolites 200, the location of the aircraft 100 may be calculated based upon the known location of the pseudolites 200 and the distance estimates between the aircraft 100 and the pseudolites 200. In certain example embodiments, the processing of signals from the pseudolites 200 and the calculation of the position estimate for the aircraft 100 may be performed in the same or similar manner to the used for GNSS signals. The signals from the pseudolites 200 may be used as an alternative to or in addition to the GNSS signals to calculate position estimates for the aircraft 100. The pseudolite navigation system 140 may also compute a velocity estimate for the aircraft 100 using the frequency difference or Doppler shift for the signals, which is also referred to as a pseudorange rate. In example embodiments, the pseudolite navigation system 140 may be configured for carrier phase measurement in order to determine a phase range measurement, and the pseudolite navigation system 140 may be configured for smoothing noisy pseudorange measurements with the precise carrier phase measurements.

In certain example embodiments, an angle of arrival estimate for the signals from the pseudolites 200 may be calculated based at least in part on data from one or more pseudolites 200. As noted above, the pseudolite receiver 142 may include a plurality of antennas spaced apart on the aircraft 100, and such antennas may be used to receive signals from the pseudolites 200 in order to calculate the angle of arrival estimate(s) for the signals from the pseudolites 200. Moreover, e.g., the pseudolite navigation system 140 may be configured to compute an elevation angle of arrival estimate and/or an azimuth angle of arrival estimate based at least in part on data the pseudolite 200 received at the antennas of the pseudolite receiver 142. The elevation angle of arrival estimate may be utilized to assist with calculating an elevation or vertical position estimate for the aircraft 100, and the azimuth angle of arrival estimate may be utilized to assist with calculating latitude and/or longitude estimates for the aircraft 100.

Turning now to FIG. 8, the positioning system 170 may calculate position and/or velocity estimates for the aircraft 100 based at least in part on a signal 202 from the pseudolite 200, which is located on the ground below the aircraft 100. In FIG. 8, the aircraft 100 is shown in flight above the ground, and one pseudolite 200 is positioned along a flight path for the aircraft 100. In certain example embodiments, the pseudolite 200 may be positioned along an approach portion or a climb portion of the flight path. It will be understood that other pseudolites may be positioned along the flight path in other example embodiments.

The clock 220 of the pseudolite 200 may be synchronized to time of the GNSS system. Thus, the clock 220 of the pseudolite 200 and the clocks of the satellites 320 may be synchronized. Such synchronization may avoid calculation of a time offset between the clock 220 of the pseudolite 200 and the clocks of the satellites 320. The synchronization of the clock 220 with the time of the GNSS system may be accurate with high integrity.

During flight, the global satellite navigation system 130 (FIG. 4) and the pseudolite navigation system 140 (FIG. 4) may compute position and/or velocity estimates for the aircraft 100. For example, as shown in FIG. 8, the global satellite navigation system 130 may receive signals 322 from satellites 320 at antennas of global satellite navigation system 130. Moreover, the signals 322 from the satellites 320 may include data corresponding to the time of transmission for the signals 322 from the satellites 320 as well as data corresponding to a position of each of the satellites 320. The global satellite navigation system 130 may utilize the time of flight and the speed of the signals 322, e.g., the speed of light, to calculate a distance estimate between the aircraft 100 and the satellites 320. With at least four satellites 320, the positioning system 170 may calculate the location estimate for the aircraft 100 based upon the known location of the satellites 320 and the distance estimates between the aircraft 100 and each of the satellites 320. The positioning system 170 may also compute a velocity estimate for the aircraft 100 using the frequency difference or Doppler shift for the signals 322 from the satellites 320. In example embodiments, the positioning system 170 may be configured for carrier phase measurement in order to determine a phase range measurement, and the positioning system 170 may be configured for smoothing noisy pseudorange measurements with the precise carrier phase measurements.

As shown in FIG. 8, the pseudolite navigation system 140 may also receive a signal 202 from the pseudolite 200 at antennas of pseudolite navigation system 140. The pseudolite 200 may be located on the ground along a flight path for the aircraft 100. The signal 202 from the pseudolite 200 may include data corresponding to the time of transmission for the signal 202 from the pseudolite 200 as well as data corresponding to a position of the pseudolite 200. The pseudolite navigation system 140 may utilize the time of flight and the speed of the signal 202, e.g., the speed of light, to calculate a distance estimate between the aircraft 100 and the pseudolite 200. With at least three satellites 320 and the pseudolite 200, the positioning system 170 may calculate the location estimate for the aircraft 100 based upon the known location of the satellites 320, the distance estimates between the aircraft 100 and each of the satellites 320, the known location of the pseudolite 200, and the distance estimate between the aircraft 100 and the pseudolite 200.

The distance estimate based on the signal 202 from the pseudolite 200 in FIG. 8 may provide various benefits for the positioning system 170. For example, the pseudolite-based distance estimate from the pseudolite navigation system 140 in combination with the satellite-based distance estimates from the global satellite navigation system 130 may advantageously increase an integrity of position and/or velocity estimates from the positioning system 170, e.g., by providing an increased number of distance estimates (e.g., relative to using only the distance estimates based on the signals 322 from the satellites 320). Thus, the pseudolite 200 may assist autonomous flight of the aircraft 100 via the positioning system 170 providing high integrity position and/or velocity estimates for the aircraft 100.

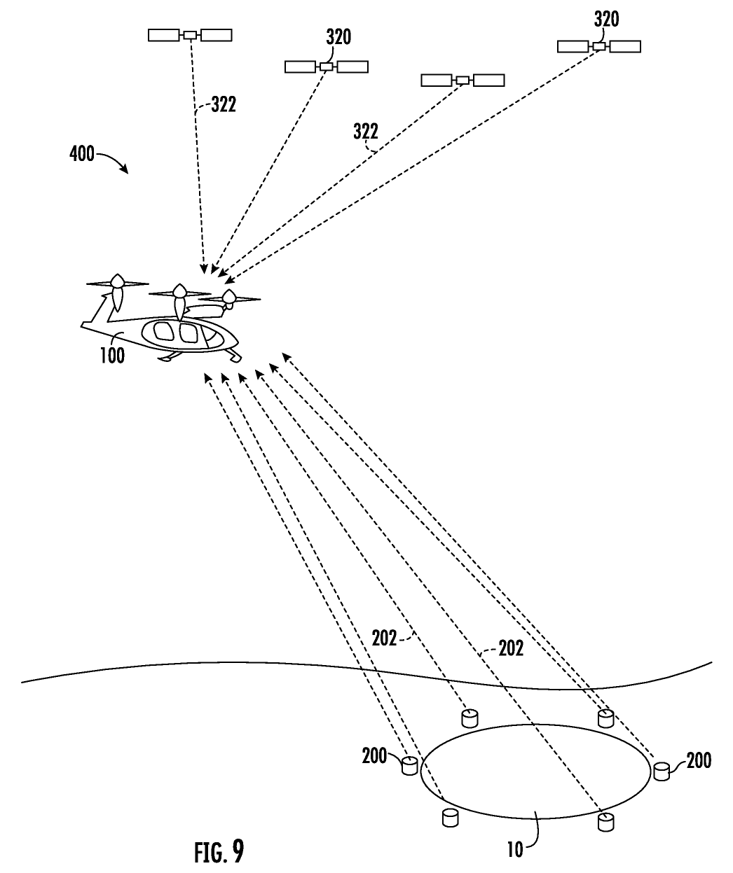

Turning now to FIG. 9, the positioning system 170 may calculate position and/or velocity estimates for the aircraft 100 based at least in part on a plurality of signals 202 from an array of pseudolites 200, which are located on the ground below the aircraft 100. In FIG. 9, the aircraft 100 is shown in flight above the ground, and the array of pseudolites 200 are disposed around a landing area 10 for the aircraft 100. Moreover, the pseudolites 200 may be positioned in a circle around the landing area 10 as shown in FIG. 9. The pseudolites 200 around the landing area 10 may assist operation of the aircraft 100, e.g., during approach, initial climb, landing, and takeoff. It will be understood that other arrangements for the pseudolites 200 may be used in other example embodiments.

During flight, the global satellite navigation system 130 and the pseudolite navigation system 140 may compute position and/or velocity estimates for the aircraft 100. For example, as shown in FIG. 9, the global satellite navigation system 130 may receive signals 322 from satellites 320 at antennas of global satellite navigation system 130. Moreover, the signals 322 from the satellites 320 may include data corresponding to the time of transmission for the signals 322 from the satellites 320 as well as data corresponding to a position of each of the satellites 320. The global satellite navigation system 130 may utilize the time of flight and the speed of the signals 322, e.g., the speed of light, to calculate a distance estimate between the aircraft 100 and the satellites 320. With at least four satellites 320, the positioning system 170 may calculate the location estimate for the aircraft 100 based upon the known location of the satellites 320 and the distance estimates between the aircraft 100 and each of the satellites 320. The positioning system 170 may also compute a velocity estimate for the aircraft 100 using the frequency difference or Doppler shift for the signals 322 from the satellites 320. In example embodiments, the positioning system 170 may be configured for carrier phase measurement in order to determine a phase range measurement, and the positioning system 170 may be configured for smoothing noisy pseudorange measurements with the precise carrier phase measurements.

As shown in FIG. 9, the pseudolite navigation system 140 may also receive signals 202 from the array of pseudolites 200 at antennas of pseudolite navigation system 140. The pseudolites 200 may be located on the ground below the aircraft 100, e.g., around the landing area 10 and/or along the flight path for the aircraft 100. The signals 202 from the pseudolites 200 may include data corresponding to the time of transmission for the signals 202 from the pseudolites 200 as well as data corresponding to positions of the pseudolites 200. The pseudolite navigation system 140 may utilize the time of flight and the speed of the signals 202, e.g., the speed of light, to calculate distance estimates between the aircraft 100 and the pseudolites 200. With at least four pseudolites 200, the positioning system 170 may calculate the location estimate for the aircraft 100 based upon the known location of the pseudolites 200 and the distance estimates between the aircraft 100 and each of the pseudolites 200. The positioning system 170 may also compute a velocity estimate for the aircraft 100 using the frequency difference or Doppler shift for the signals 202 from the pseudolites 200. In example embodiments, the positioning system 170 may be configured for carrier phase measurement in order to determine a phase range measurement, and the positioning system 170 may be configured for smoothing noisy pseudorange measurements with the precise carrier phase measurements.

The clocks 220 of the pseudolites 200 may be synchronized to time of the GNSS system. Thus, the clocks 220 of the pseudolites 200 and the clocks of the satellites 320 may be synchronized. Such synchronization may avoid calculation of time offsets between the clocks 220 of the pseudolites 200 and the clocks of the satellites 320. The synchronization of the clocks 220 with the time of the GNSS system may be accurate with high integrity. As an example, each of the pseudolites 200 may include a GNSS receiver, which can receive signals 322 from the satellites 320 to set the clock 220 to the GNSS time. As another example, at least one of the pseudolites 200 may include the GNSS receiver to determine a master clock time for the pseudolites 200, and the clocks 220 of the other pseudolites 200 (without the GNSS receiver) may be set by distributing the master clock time via a cable, line-of-sight link (such as a laser link or radio link), or other mechanism.

The position and/or velocity estimates based on the signals 202 from the pseudolites 200 in FIG. 9 may provide various benefits for the positioning system 170. For example, the pseudolite-based position and/or velocity estimates from the pseudolite navigation system 140 may advantageously provide for continuous operation of the positioning system 170, e.g., without access to GNSS data, such during spoofing and/or jamming of the signals 322 of satellites 320. Thus, the pseudolites 200 may assist autonomous flight of the aircraft 100 via the positioning system 170 providing high integrity position and/or velocity estimates for the aircraft 100 without reference to GNSS-based estimates. As another example, the pseudolite-based distance estimates from the pseudolite navigation system 140 in combination with the satellite-based distance estimates from the global satellite navigation system 130 may advantageously increase an integrity of position and/or velocity estimates from the positioning system 170, e.g., by providing an increased number of distance estimates (e.g., relative to using only the distance estimates based on the signals 322 from the satellites 320 or the distance estimates based on the signals 202 from the pseudolites 200. Thus, the pseudolites 200 may assist autonomous flight of the aircraft 100 via the positioning system 170 providing high integrity position and/or velocity estimates for the aircraft 100.

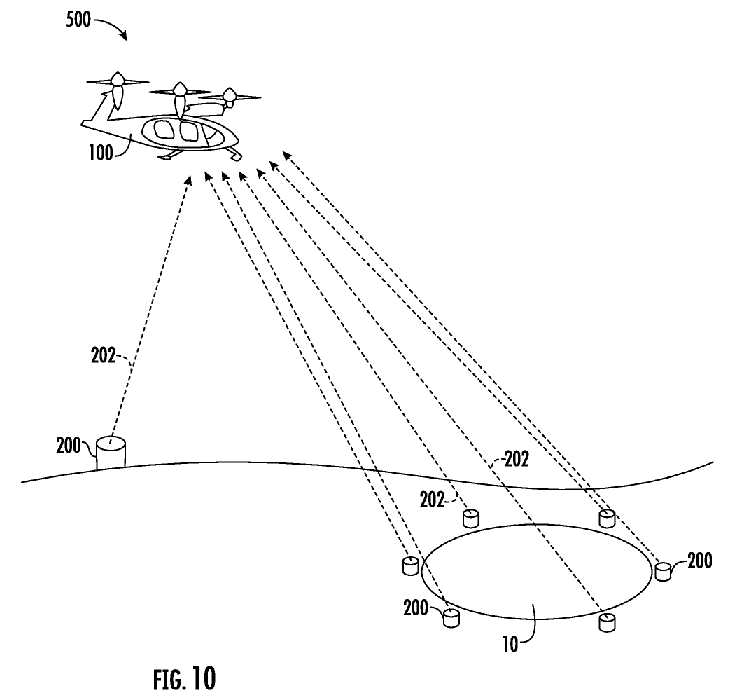

Turning now to FIG. 10, the positioning system 170 may calculate position and/or velocity estimates for the aircraft 100 based at least in part on a plurality of signals 202 from pseudolites 200, which are located on the ground below the aircraft 100. In FIG. 9, the aircraft 100 is shown in flight above the ground, and a pseudolite 200 is disposed along a flight path for the aircraft 100 and an array of pseudolites 200 are disposed around a landing area 10 for the aircraft 100. However, it will be understood that other arrangements for the pseudolites 200 may be used in other example embodiments.

During flight, the pseudolite navigation system 140 may compute position estimates for the aircraft 100. For example, as shown in FIG. 10, the pseudolite navigation system 140 may receive signals 202 from the array of pseudolites 200 at antennas of pseudolite navigation system 140. The pseudolites 200 may be located on the ground below the aircraft 100, e.g., around the landing area 10 and/or along the flight path for the aircraft 100. The signals 202 from the pseudolites 200 may include data corresponding to the time of transmission for the signals 202 from the pseudolites 200 as well as data corresponding to positions of the pseudolites 200. The pseudolite navigation system 140 may utilize the time of flight and the speed of the signals 202, e.g., the speed of light, to calculate distance estimates between the aircraft 100 and the pseudolites 200. With at least four pseudolites 200, the positioning system 170 may calculate the location estimate for the aircraft 100 based upon the known location of the pseudolites 200 and the distance estimates between the aircraft 100 and each of the pseudolites 200.

The position and/or velocity estimates based on the signals 202 from the pseudolites 200 in FIG. 10 may provide various benefits for the positioning system 170. For example, the pseudolite-based position and/or velocity estimates from the pseudolite navigation system 140 may advantageously provide for continuous operation of the positioning system 170, e.g., without access to GNSS data, such during spoofing and/or jamming of satellites. Thus, the pseudolites 200 may assist autonomous flight of the aircraft 100 via the positioning system 170 providing high integrity position and/or velocity estimates for the aircraft 100 without reference to GNSS-based estimates.

With reference to FIGS. 5, 9, and 10, the arrangement of the pseudolite receiver 142 on the aircraft 100 may also allow for angle of arrival estimates. The angle of arrival estimates for the aircraft 100 may assist, e.g., vertical, position estimates on approach, landing, takeoff, and climb, such as when all pseudolites are located at the landing area 10. In some example embodiments, the positioning system 170 may utilize both time of flight and angle of arrival to estimate the position of the aircraft 100. As another example, the positioning system 170 may utilize position estimates via the angle of arrival to check the integrity of position estimates via the time of flight.

Vertical dilution of precision may deteriorate significantly for time of arrival measurements when all pseudolites 200 are located at the landing area 10, and the aircraft 100 approaches the landing area 10 with a low flight path angle, such as between three degrees (3°) and seven degrees (7°). Synchronizing the clocks 220 of the pseudolites 200 to the time of the GNSS system may advantageously reduce vertical dilution of precision for the angle of arrival estimates. Thus, the vertical position estimates may be improved on approach, landing, takeoff, and climb by synchronizing the clocks 220 of the pseudolites 200 to the time of the GNSS system.

In certain instances, when signals 322 from satellites 320 are available for computing position estimates in combination with signals 202 from the pseudolites 200 as shown in FIG. 9, the integrity of the position estimates from the positioning system 170 may not require calculation of the angle of arrival estimates for autonomous flight of the aircraft 100 when the clocks 220 of the pseudolites 200 are synchronized to the time of the GNSS system. Conversely, in certain instances, when satellites are unavailable for computing position estimates as shown in FIG. 10 or when the clocks 220 of the pseudolites 200 are not synchronized to the time of the GNSS system, the positioning system 170 may utilize the signals 202 from the pseudolites 200 to calculate angle of arrival estimates in combination with pseudorange estimates to assist with the initial approach, landing, takeoff, and climb of the aircraft at the landing area 10. In general, the positioning system 170 may utilize angle of arrival estimates for the aircraft 100 to assist position estimates on approach, landing, takeoff, and climb, and the clocks 220 of the pseudolites 200 may be synchronized to the time of the GNSS system to facilitate position estimates.

As noted above, the clock 144 of the pseudolite navigation system 140 may be highly stable, e.g., such that the timing error of the clock 144 is less than one microsecond per twenty-four hours (< 1µs/24hrs). Thus, the vertical position (i.e., altitude) estimates of the positioning system 170 may be significantly improved relative to systems with less stable clocks. For example, the clock 144 of the pseudolite navigation system 140 may be synchronized to the time of the GNSS system, and the pseudolites 200 may also be synchronized to the time of the GNSS system. When satellites are unavailable for computing position estimates as shown in FIG. 10, the clock 144 of the pseudolite navigation system 140 may continue to allow for computing high integrity position estimates for the aircraft 100 without reference to GNSS-based position estimates due to the stability of the clock 144. Thus, e.g., the clock 144 of the pseudolite navigation system 140 may advantageously reduce the number of signals 202 from pseudolites 200 required to calculate position and/or velocity estimates for the aircraft 100 from four (4) pseudolites 200 to three (3) pseudolites 200 due to the clock 144 allowing calculation of position and/or velocity estimates without a clock offset for the pseudolite navigation system 140 and the pseudolites 200 relative to GNSS time. Moreover, the clock 144 of the pseudolite navigation system 140 may also mitigate the vertical dilution of precision described above.

As may be seen from the above, the positioning system 170 may utilize pseudolite-based position and/or velocity estimates, e.g., rather than GNSS-based estimates or in addition to GNSS-based estimates. Thus, e.g., the pseudolite-based portions of the positioning system 170 may allow for estimating the velocity and position of the aircraft 100 without reliance upon GNSS data or may increase the integrity of the velocity and position estimates by using both pseudolite data and GNSS data.

FIG. 11 illustrates a method 600 for pseudolite-based estimating of a position and/or velocity of an aircraft according to example implementations of the present disclosure. One or more portions of the method 600 may be implemented by one or more computing devices such as for example, the computing devices/systems described in reference to the other figures. Moreover, one or more portions of the method 600 may be implemented as an algorithm on the hardware components of the device/systems described herein. For example, a computing system may include one or more processors and one or more non-transitory, computer-readable media storing instructions that are executable by the one or more processors to perform operations, the operations including one or more of the operations/portions of method 600.

FIG. 11 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, or modified in various ways without deviating from the scope of the present disclosure.

Method 600 is described in greater detail below in the context of the aircraft 100. However, it will be understood that method 600 may be used in or with other aircraft and avionics systems to provide location estimates for an aircraft during flight.

At 610, a computing system (e.g., positioning system 170) may access data corresponding to a signal from each of a plurality of global navigation satellites. For example, with reference to FIGS. 4, 5, and 8, the global satellite navigation system 130 may receive the signals 322 from the satellites 320 at antennas of the global satellite navigation system 130. In example embodiments, the global satellite navigation system 130 may receive signals 322 from one, two, three, or more of the satellites 320 at 610. The signals 322 may include, e.g., the time of transmission for the signals from the satellites 320 and a position of the satellites 320, encoded onto the signals 322.

At 620, the computing system (e.g., positioning system 170) may access data corresponding to a signal from at least one pseudolite. For example, with reference to FIGS. 4, 5, and 8, the pseudolite navigation system 140 may receive the signals 202 from the pseudolite 200 at antennas of the pseudolite receiver 142. In example embodiments, the pseudolite navigation system 140 may receive signals 202 from one, two, three, or more pseudolite 200 at 620. The signals 202 from the pseudolites 200 may include, e.g., the time of transmission for the signals 202 from the pseudolite 200 and a position of the pseudolites 200, encoded onto the signals 202.

At 630, the computing system (e.g., positioning system 170) may compute a position estimate of the aircraft based at least in part on the data from 610 and the data from 620. Thus, e.g., the positioning system 170 may compute the position estimate for the aircraft 100 based at least in part on signals 322 from the satellites 320 and signals 202 from the pseudolites 200. For example, the positioning system 170 may utilize the signals 202 from the pseudolites 200 to advantageously increase an integrity of position and/or velocity estimates from the positioning system 170, e.g., by providing an increased number of distance estimates (e.g., relative to using only the distance estimates based on the signals 322 from the satellites 320). As another example, the positioning system 170 may compute the position estimate without access to the data from 610, such during spoofing and/or jamming of satellites 320. Thus, the positioning system 170 may provide continuous operation, e.g., without access to GNSS data.

As an example, at 630, the global satellite navigation system 130 may compute estimates for the position of the aircraft 100 based at least in part on the signals 322 from the satellites 320. For example, the global satellite navigation system 130 may utilize the time of flight and the speed of the signals 322, e.g., the speed of light, to calculate a distance estimate between the aircraft 100 and the satellites 320. With at least four satellites 320, the positioning system 170 may calculate the location estimate for the aircraft 100 based upon the location of the satellites 320 and the distance estimates between the aircraft 100 and each of the satellites 320. In addition, the pseudolite navigation system 140 may compute estimates for the position of the aircraft 100 based at least in part on the signals 202 from the pseudolites 200. For example, the pseudolite navigation system 140 may utilize the time of flight and the speed of the signals 202, e.g., the speed of light, to calculate a distance estimate between the aircraft 100 and the pseudolites 200. With at least four pseudolites 200, the positioning system 170 may calculate the location estimate for the aircraft 100 based upon the location of the pseudolites 200 and the distance estimates between the aircraft 100 and each of the pseudolites 200. Thus, at 630, the global satellite navigation system 130 and the pseudolite navigation system 140 may compute separate position estimates for the aircraft 100, and the positioning system 170 may compute a higher integrity position estimate for the aircraft 100 based on the estimates from the separate position estimates from the global satellite navigation system 130 and the pseudolite navigation system 140.

As another example, at 630, the global satellite navigation system 130 may utilize the time of flight and the speed of the signals 322, e.g., the speed of light, to calculate a distance estimate between the aircraft 100 and the satellites 320, and the pseudolite navigation system 140 may utilize the time of flight and the speed of the signal 202, e.g., the speed of light, to calculate a distance estimate between the aircraft 100 and the pseudolite 200. With at least four signals 202, 322 from the satellites 320 and the pseudolites 200, the positioning system 170 may calculate the location estimate for the aircraft 100 based upon the known location of the satellites 320, the distance estimates between the aircraft 100 and each of the satellites 320, the known location of the pseudolite 200, and the distance estimate between the aircraft 100 and the pseudolite 200. With five or more signals 202, 322, the positioning system 170 may compute higher integrity position estimates for the aircraft 100. For processing of both the satellite data and the pseudolite data, the positioning system 170 estimates a clock offset between the clock of the global satellite navigation system 130 and the clock 144 of the pseudolite navigation system 140.

In certain example embodiments, a clock of the computing device (e.g., positioning system 170) may be synchronized to the time of the global navigation satellites at 630. Thus, e.g., the clock 144 of the pseudolite navigation system 140 may be synchronized to the time of the satellites 320. The timing error of the clock 144 may be less than one microsecond per twenty-four hours (< 1µs/24hrs). By utilizing the clock 144 with low timing error, the positioning system 170 can advantageously calculate a vertical position estimate for the aircraft 100 at 630 with significantly greater integrity relative to using other clocks with greater timing errors. In addition, the utilizing the clock 144 having the above-described timing error, the pseudolite navigation system 140 can advantageously provide high integrity position estimates at 630 even without access to the data from 610, such during GNSS spoofing and/or jamming.

FIG. 12 depicts example system components of a computing system 1005 according to example implementations of the present disclosure. The computing system 1005 may include one or more computing devices 1010. The computing devices 1010 of the computing system 1005 may include one or more processors 1015 and a memory 1020. The processors 1015 can be any suitable processing device (e.g., a processor core, a microprocessor, an ASIC, a FPGA, a controller, a microcontroller, etc.) and may be one processor or a plurality of processors that are operatively connected. The memory 1020 can include one or more non-transitory computer-readable storage media, such as RAM, ROM, EEPROM, EPROM, one or more memory devices, flash memory devices, etc., and combinations thereof.

The memory 1020 may store information that can be accessed by the processors 1015. For instance, the memory 1020 (e.g., one or more non-transitory computer-readable storage mediums, memory devices) may include computer-readable instructions 1025 that can be executed by the processors 1015. The instructions 1025 may be software written in any suitable programming language or may be implemented in hardware. Additionally, or alternatively, the instructions 1025 may be executed in logically or virtually separate threads on processors 1015.

For example, the memory 1020 may store instructions 1025 that when executed by the processors 1015 cause the processors 1015 to perform operations such as any of the operations and functions of any of the computing systems (e.g., aircraft system) or computing devices (e.g., the flight computer), as described herein.

The memory 1020 may store data 1030 that can be obtained, received, accessed, written, manipulated, created, or stored. The data 1030 may include, for instance, input data, trim values, output data, or other data/information described herein. In some implementations, the computing devices 1010 may access from or store data in one or more memory devices that are remote from the computing system 1005.

The computing devices 1010 can also include a communication interface 1035 used to communicate with one or more other systems. The communication interface 1035 may include any circuits, components, software, etc. for communicating via one or more networks. In some implementations, the communication interface 1035 may include for example, one or more of a communications controller, receiver, transceiver, transmitter, port, conductors, software or hardware for communicating data/information.

FIG. 12 illustrates one example computing system 1005 that may be used to implement the present disclosure. Other computing systems can be used as well. Computing tasks discussed herein as being performed at computing devices onboard the aircraft may instead be performed remote from the aircraft (e.g., a network connected computing system), or vice versa. Such configurations may be implemented without deviating from the scope of the present disclosure. The use of computer-based systems allows for a great variety of possible configurations, combinations, and divisions of tasks and functionality between and among components. Computer-implemented operations may be performed on a single component or across multiple components. Computer-implemented tasks or operations may be performed sequentially or in parallel. Data and instructions may be stored in a single memory device or across multiple memory devices.

Aspects of the disclosure have been described in terms of illustrative implementations thereof. Numerous other implementations, modifications, or variations within the scope and spirit of the appended claims can occur to persons of ordinary skill in the art from a review of this disclosure. Any and all features in the following claims can be combined or rearranged in any way possible. Accordingly, the scope of the present disclosure is by way of example rather than by way of limitation, and the subject disclosure does not preclude inclusion of such modifications, variations or additions to the present subject matter as would be readily apparent to one of ordinary skill in the art.

Terms are described herein using lists of example elements joined by conjunctions such as “and,” “or,” “but,” etc. It should be understood that such conjunctions are provided for explanatory purposes only. Lists joined by a particular conjunction such as “or,” for example, can refer to “at least one of” or “any combination of” example elements listed therein, with “or” being understood as “or” unless otherwise indicated. Also, terms such as “based on” should be understood as “based at least in part on.” As used herein, the terms “first,” “second,” and “third” may be used interchangeably to distinguish one component from another and are not intended to signify location or importance of the individual components. The terms “includes” and “including” are intended to be inclusive in a manner similar to the term “comprising.”

Those of ordinary skill in the art, using the disclosures provided herein, will understand that the elements of any of the claims, operations, or processes discussed herein can be adapted, rearranged, expanded, omitted, combined, or modified in various ways without deviating from the scope of the present disclosure. At times, elements can be listed in the specification or claims using a letter reference for exemplary illustrated purposes and is not meant to be limiting. Letter references, if used, do not imply a particular order of operations or a particular importance of the listed elements. For instance, letter identifiers such as (a), (b), (c), . . . , (i), (ii), (iii), . . . , etc. may be used to illustrate operations or different elements in a list. Such identifiers are provided for the ease of the reader and do not denote a particular order, importance, or priority of steps, operations, or elements. For instance, an operation illustrated by a list identifier of (a), (i), etc. can be performed before, after, or in parallel with another operation illustrated by a list identifier of (b), (ii), etc.

Approximating language, as used herein throughout the specification and claims, is applied to modify any quantitative representation that could permissibly vary without resulting in a change in the basic function to which it is related. Accordingly, a value modified by a term or terms, such as “about,” “approximately,” and “substantially,” are not to be limited to the precise value specified. In at least some instances, the approximating language may correspond to the precision of an instrument for measuring the value. For example, the approximating language may refer to being within a ten percent (10%) margin.

The terms “coupled,” “fixed,” “attached to,” and the like refer to both direct coupling, fixing, or attaching, as well as indirect coupling, fixing, or attaching through one or more intermediate components or features, unless otherwise specified herein.

For purposes of the description hereinafter, the terms “upper”, “lower”, “right”, “left”, “vertical”, “horizontal”, “top”, “bottom”, “lateral”, “longitudinal”, and derivatives thereof shall relate to the embodiments as they are oriented in the drawing figures. However, it is to be understood that the embodiments may assume various alternative variations, except where expressly specified to the contrary. It is also to be understood that the specific devices illustrated in the attached drawings, and described in the following specification, are simply embodiments of the disclosure. Hence, specific dimensions and other physical characteristics related to the embodiments disclosed herein are not to be considered as limiting.

### EXAMPLE EMBODIMENTS

First example embodiment: A method for avionic positioning, comprising: accessing, with a computing device on an aircraft, data corresponding to a signal from each of a plurality of global navigation satellites; accessing, with the computing device, data corresponding to a signal from each of at least one pseudolite, each of the at least one pseudolite synchronized to a time of the global navigation satellites; and computing, with the computing device, a position estimate of the aircraft based at least in part on the data corresponding to the signal from each of the plurality of global navigation satellites and the data corresponding to the signal from each of the at least one pseudolite, wherein a clock of the computing device is synchronized to the time of the global navigation satellites, and the clock has a timing error less than one microsecond per twenty-four hours.

Second example embodiment: The method of the first example embodiment, wherein the clock comprises one or both of a chip scale atomic clock and a miniature atomic clock.

Third example embodiment: The method of either the first example embodiment or the second example embodiment, wherein each of the at least one pseudolite comprises a respective clock with a timing error less than one microsecond per twenty-four hours.

Fourth example embodiment: The method of any one of the first through third example embodiments, wherein the signal from each of the at least one pseudolite comprises a signal from each of the at least one pseudolite along a flight path of the aircraft.

Fifth example embodiment: The method of any one of the first through fourth example embodiments, wherein the signal from each of the at least one pseudolite comprises a plurality of signals from each of a plurality of pseudolites at a landing area for the aircraft.

Sixth example embodiment: The method of any one of the first through fifth example embodiments, further comprising computing, with the computing device, an angle of arrival for the signal from each of the at least one pseudolite based at least in part on the data corresponding to the signal from each of at least one pseudolite.

Seventh example embodiment: A system for avionic positioning, comprising: an aircraft; one or more processors located onboard the aircraft; a clock in communication with the one or more processors; and one or more non-transitory computer-readable media that store instructions that are executable by the one or more processors to perform operations, the operations comprising accessing data corresponding to a signal from each of a plurality of global navigation satellites, accessing data corresponding to a signal from each of at least one pseudolite when each of the at least one pseudolite is synchronized to a time of the global navigation satellites, and computing a position estimate of the aircraft based at least in part on the data corresponding to the signal from each of the plurality of global navigation satellites and the data corresponding to the signal from each of the at least one pseudolite, wherein the clock is synchronized to the time of the global navigation satellites, and the clock has a timing error less than one microsecond per twenty-four hours.

Eighth example embodiment: The method of the seventh example embodiment, wherein the clock comprises one or both of a chip scale atomic clock and a miniature atomic clock.

Nineth example embodiment: The method of either the seventh example embodiment or eighth example embodiment, wherein the signal from each of the at least one pseudolite comprises a signal from each of the at least one pseudolite along a flight path of the aircraft.

Tenth example embodiment: The method of any one of the seventh through nineth example embodiments, wherein the signal from each of the at least one pseudolite comprises a plurality of signals from each of a plurality of pseudolites at a landing area for the aircraft.

Eleventh example embodiment: The method of any one of the seventh through tenth example embodiments, wherein the instructions further comprise computing an angle of arrival for the signal from each of the at least one pseudolite based at least in part on the data corresponding to the plurality of signals from each of the plurality of pseudolites.

Twelfth example embodiment: A method for avionic positioning, comprising: accessing, with a first computing device on an aircraft, data corresponding to a signal from each of a plurality of global navigation satellites; accessing, with a second computing device on the aircraft, data corresponding to a signal from each of at least one pseudolites, each of the at least one pseudolites synchronized to a time of the global navigation satellites; computing an offset estimate between a clock of the first computing device and a clock of the second computing device, wherein the clock of the second computing device has a timing error less than one microsecond per twenty-four hours; and computing a position estimate of the aircraft based at least in part on the data corresponding to the signal from each of the plurality of global navigation satellites, the data corresponding to the signal from each of the at least one pseudolites, and the offset estimate.

Thirteenth example embodiment: The method of the twelfth example embodiment, wherein the clock of the second computing device comprises one or both of a chip scale atomic clock and a miniature atomic clock.

Fourteenth example embodiment: The system of either the twelfth example embodiment or the thirteenth example embodiment, wherein each of the at least one pseudolite comprises a respective clock with a timing error less than one microsecond per twenty-four hours.

Fifteenth example embodiment: The system of any one of the twelfth through fourteenth example embodiments, wherein the signal from each of the at least one pseudolite comprises a signal from each of the at least one pseudolite along a flight path of the aircraft.

Sixteenth example embodiment: The system of any one of the twelfth through fifteenth example embodiments, wherein the signal from each of the at least one pseudolite comprises a plurality of signals from each of a plurality of pseudolites at a landing area for the aircraft.

Seventeenth example embodiment: The system of any one of the twelfth through sixteenth example embodiments, further comprising computing an angle of arrival for the signal from each of the at least one pseudolite based at least in part on the data the data corresponding to the plurality of signals from each of the plurality of pseudolites.

Eighteenth example embodiment: A system for avionic positioning, comprising: an aircraft; a global navigation satellite system located onboard the aircraft, the global navigation satellite system configured for receiving data corresponding to a signal from each of a plurality of global navigation satellites, the global navigation satellite system comprising a clock; a pseudolite navigation system located onboard the aircraft, the pseudolite navigation system configured for receiving data corresponding to a signal from each of at least one pseudolite, the pseudolite navigation system comprising a clock with a timing error less than one microsecond per twenty-four hours, one or more processors, and one or more non-transitory computer-readable media that store instructions that are executable by the one or more processors to perform operations, the operations comprising accessing data corresponding to the signal from each of at least one pseudolites when each of the at least one pseudolites is synchronized to a time of the global navigation satellites, computing an offset estimate between the clock of the global navigation satellite system and the clock of the pseudolite navigation system, and computing a position estimate of the aircraft based at least in part on the data corresponding to the signal from each of the plurality of global navigation satellites, the data corresponding to the signal from each of the at least one pseudolites, and the offset estimate.

Nineteenth example embodiment: The system of the eighteenth example embodiment, wherein the clock of the pseudolite navigation system comprises one or both of a chip scale atomic clock and a miniature atomic clock.

Twentieth example embodiment: The system of either the eighteenth example embodiment or the nineteenth example embodiment, wherein the signal from each of the at least one pseudolite comprises a signal from each of the at least one pseudolite along a flight path of the aircraft.

Twenty-first example embodiment: The system of any one of the eighteenth through twentieth example embodiments, wherein the signal from each of the at least one pseudolite comprises a plurality of signals from each of a plurality of pseudolites at a landing area for the aircraft.

Twenty-second example embodiment: The system of any one of the eighteenth through twenty-first example embodiments, wherein the instructions further comprise computing an angle of arrival for the signal from each of the at least one pseudolite based at least in part on the data corresponding to the plurality of signals from each of the plurality of pseudolites.

Twenty-third example embodiment: A method for estimating an aircraft position, substantially as herein described.

Twenty-fourth example embodiment: A system for estimating an aircraft position, substantially as herein described.

What is claimed is:

1. A method for avionic positioning, comprising:
accessing, with a computing device on an aircraft, data corresponding to a signal from each of a plurality of global navigation satellites;
accessing, with the computing device, data corresponding to a signal from each of at least one pseudolite, each of the at least one pseudolite synchronized to a time of the global navigation satellites; and
computing, with the computing device, a position estimate of the aircraft based at least in part on the data corresponding to the signal from each of the plurality of global navigation satellites and the data corresponding to the signal from each of the at least one pseudolite, wherein a clock of the computing device is synchronized to the time of the global navigation satellites, and the clock has a timing error less than one microsecond per twenty-four hours.

2. The method of claim 1, wherein the clock comprises one or both of a chip scale atomic clock and a miniature atomic clock.

3. The method of claim 1, wherein each of the at least one pseudolite comprises a respective clock with a timing error less than one microsecond per twenty-four hours.

4. The method of claim 1, wherein the signal from each of the at least one pseudolite comprises a signal from each of the at least one pseudolite along a flight path of the aircraft.

5. The method of claim 1, wherein the signal from each of the at least one pseudolite comprises a plurality of signals from each of a plurality of pseudolites at a landing area for the aircraft.

6. The method of claim 5, further comprising computing, with the computing device, an angle of arrival for the signal from each of the at least one pseudolite based at least in part on the data corresponding to the signal from each of the at least one pseudolite.

7. The method of claim 1, further comprising:
accessing, with the computing device, updated data corresponding to the signal from each of the at least one pseudolite; and
computing, with the computing device, an updated position estimate of the aircraft based at least in part on the updated data corresponding to the signal from each of the at least one pseudolite, wherein updated data corresponding to the signal from each of the plurality of global navigation satellites is unavailable when the updated position estimate of the aircraft is computed,
wherein the at least one pseudolite comprises three ground-based pseudolites.

8. The method of claim 1, wherein:
the signal from each of at least one pseudolite comprises a time of transmission for the signal from each of at least one pseudolite; and
computing the position estimate of the aircraft comprises computing a time of arrival for the signal from each of at least one pseudolite based at least in part on a time of the clock when the signal from each of at least one pseudolite arrives at the aircraft.

9. The method of claim 1, wherein a respective position of the at least one pseudolite is encoded within the signal from each of at least one pseudolite, or a position of the at least one pseudolite is stored within a database onboard the aircraft.

10. A system for avionic positioning, comprising:
an aircraft;
one or more processors located onboard the aircraft;
a clock in communication with the one or more processors; and
one or more non-transitory computer-readable media that store instructions that are executable by the one or more processors to perform operations, the operations comprising
accessing data corresponding to a signal from each of a plurality of global navigation satellites,
accessing data corresponding to a signal from each of at least one pseudolite when each of the at least one pseudolite is synchronized to a time of the global navigation satellites, and
computing a position estimate of the aircraft based at least in part on the data corresponding to the signal from each of the plurality of global navigation satellites and the data corresponding to the signal from each of the at least one pseudolite,
wherein the clock is synchronized to the time of the global navigation satellites, and the clock has a timing error less than one microsecond per twenty-four hours.

11. The system of claim 10, wherein the clock comprises one or both of a chip scale atomic clock and a miniature atomic clock.

12. The system of claim 10, wherein the signal from each of the at least one pseudolite comprises a signal from each of the at least one pseudolite along a flight path of the aircraft.

13. The system of claim 10, wherein the signal from each of the at least one pseudolite comprises a plurality of signals from each of a plurality of pseudolites at a landing area for the aircraft.

14. The system of claim 13, wherein the instructions further comprise computing an angle of arrival for the signal from each of the at least one pseudolite based at least in part on the data corresponding to the plurality of signals from each of the plurality of pseudolites.

15. A method for avionic positioning, comprising:
accessing, with a first computing device on an aircraft, data corresponding to a signal from each of a plurality of global navigation satellites;
accessing, with a second computing device on the aircraft, data corresponding to a signal from each of at least one pseudolites, each of the at least one pseudolites synchronized to a time of the global navigation satellites;
computing an offset estimate between a clock of the first computing device and a clock of the second computing device, wherein the clock of the second computing device has a timing error less than one microsecond per twenty-four hours; and
computing a position estimate of the aircraft based at least in part on the data corresponding to the signal from each of the plurality of global navigation satellites, the data corresponding to the signal from each of the at least one pseudolites, and the offset estimate.

16. The method of claim 15, wherein the clock of the second computing device comprises one or both of a chip scale atomic clock and a miniature atomic clock.

17. The method of claim 15, wherein each of the at least one pseudolite comprises a respective clock with a timing error less than one microsecond per twenty-four hours.

18. The method of claim 15, wherein the signal from each of the at least one pseudolite comprises a signal from each of the at least one pseudolite along a flight path of the aircraft.

19. The method of claim 15, wherein the signal from each of the at least one pseudolite comprises a plurality of signals from each of a plurality of pseudolites at a landing area for the aircraft.

20. The method of claim 19, further comprising computing an angle of arrival for the signal from each of the at least one pseudolite based at least in part on the data the data corresponding to the plurality of signals from each of the plurality of pseudolites.
